(19) United States
(12) Patent Application Publication
(10) Pub. No.: US 2011/0268920 A1
(43) Pub. Date: Nov. 3, 2011

(54) TIN-PLATED PRODUCT AND METHOD FOR PRODUCING SAME

(75) Inventors: Hiroshi Miyazawa, Saitama (JP); Masami Saitou, Saitama (JP); Takayoshi Endo, Shizuoka (JP); Takaya Kondo, Shizuoka (JP)

(73) Assignee: DOWA METALTECH CO., LTD., Tokyo (JP)

(21) Appl. No.: 13/179,986

(22) Filed: Jul. 11, 2011

Related U.S. Application Data
(62) Division of application No. 11/378,124, filed on Mar. 16, 2006, now abandoned.

(30) Foreign Application Priority Data
Mar. 24, 2005 (JP) 2005-086074

(51) Int. Cl. B32B 5/16; C09D 1/00; B32B 15/00

(52) U.S. Cl. 428/143; 428/646; 428/457; 106/286.4

(57) ABSTRACT

A tin-plated product formed by electroplating a substrate in a tin plating solution, which contains carbon particles and an aromatic carbonyl compound, to form a coating of a composite material, which contains the carbon particles in a tin layer, on the substrate has a coefficient of friction which is not greater than 0.18, preferably not greater than 0.13, with respect to the same kind of another tin-plated product, and has a glossiness of not less than 0.29 and a contact resistance of not greater than 1.0 mΩ. The coating has a thickness of 0.5 to 10 micrometers, and the content of carbon in the coating is in the range of from 0.1% by weight to 1.5% by weight. Separate protrusions containing the carbon particles are formed on the surface of the coating. The orientation plane of a tin matrix of the coating is (101) plane.

### BACKGROUND OF THE INVENTION

1. Field of the Invention

The present invention generally relates to a tin-plated product and a method for producing the same. More specifically, the invention relates to a tin-plated product used as the material of an insertable connecting terminal or the like, and a method for producing the same.

2. Description of the Prior Art

As conventional materials of insertable connecting terminals, there are used tin-plated products wherein a tin coating layer is formed as the outermost layer of a conductive material, such as copper or a copper alloy. In particular, tin-plated products have a small contact resistance, and are used as the materials of connecting terminals for automotive vehicles and so forth.

However, there is a problem in that tin-plated products are soft and easy to be deformed when they are used as insertable connecting terminals to be connected to each other, so that they have a high coefficient of friction during the insertion thereof. In addition, since recent connecting terminals for automotive vehicles have multipolar terminals, the inserting force applied thereto during assembly is increased in proportion to the number of multipolar terminals, so that there is a problem in that work load increases.

In order to eliminate such a problem, reflow-treated tin-plated products obtained by treating tin-plated materials by a reflow treatment are used as typical materials of connecting terminals for automotive vehicles and so forth. The coefficient of friction of such a reflow-treated tin-plated product is reduced by decreasing the thickness of the tin coating layer serving as a soft layer and by forming a hard tin alloy layer as an underlayer by a reflow treatment. In addition, it is proposed that a coating of a composite material, which contains wear resistant or lubricating solid particles in a metal matrix containing tin as a principal component, is formed on a conductive substrate by electroplating to improve the mechanical wear resistance of a tin-plated product (see, e.g., Japanese Patent Laid-Open Nos. 54-45634, 53-11131 and 63-145819), and there is proposed a connecting terminal to which such a composite coating is applied (see, e.g., Japanese Patent Unexamined Publication No. 2001-526734 (National Publication of Translated Version of PCT/US96/19768). It is also proposed that a coating containing tin or tin/lead and graphite dispersed therein is formed on a conductive substrate to form a conductive coating having an excellent wear resistance (see, e.g., Japanese Patent Laid-Open No. 61-227196).

However, typical reflow-treated tin-plated products have a relatively high coefficient of friction which is in the range of from about 0.2 to about 0.25, and the tin-plated products produced by the above described methods also have a relatively high coefficient of friction. In particular, the coefficient of friction of the composite coating containing tin and graphite proposed in Japanese Patent Laid-Open No. 61-227196 is about 0.2. Therefore, if such a tin-plated product is used as the material of an insertable connecting terminal, there is a problem in that the inserting force applied thereto increases

### SUMMARY OF THE INVENTION

It is therefore an object of the present invention to eliminate the aforementioned problems and to provide a tin-plated product which has a very low coefficient of friction, and a method for producing the same.

In order to accomplish the aforementioned and other objects, the inventors have diligently studied and found that it is possible to produce a tin-plated product which has a very low coefficient of friction, if a coating of a composite material containing carbon particles in a tin layer is formed on a substrate by electroplating using a tin plating solution which contains carbon particles and an aromatic carbonyl compound. Thus, the inventors have made the present invention.

According one aspect of the present invention, there is provided a method for producing a tin-plated product, the method comprising the steps of: adding carbon particles and an aromatic carbonyl compound to a tin plating solution; and electroplating a substrate in the tin plating solution, which contains the carbon particles and the aromatic carbonyl compound, to form a coating of a composite material, which contains the carbon particles in a tin layer, on the substrate. In this method for producing a tin-plated product, the aromatic carbonyl compound is preferably an aromatic aldehyde or an aromatic ketone.

According to another aspect of the present invention, a tin-plated product comprises: a substrate; and a coating of a composite material which contains carbon particles in a tin layer, the coating being formed on the substrate, wherein the tin-plated product has a coefficient of friction which is not greater than 0.18 with respect to the same kind of another tin-plated product as that thereof. Preferably, in this tin-plated product, the coefficient of friction is not greater than 0.13, and the coating has a glossiness of not less than 0.29. The coating preferably has a thickness of 0.5 to 10 micrometers, and the content of carbon in the coating is preferably in the range of from 0.1% by weight to 1.5% by weight. The tin-plated product preferably has a contact resistance of not greater than 1.0 mΩ. A plurality of protrusions spaced from each other are preferably formed on a surface of the coating, and each of the protrusions preferably contains the carbon particles. Moreover, the orientation plane of a tin matrix of the tin-plated product is preferably (101) plane.

According to a further aspect of the present invention, a connecting terminal comprises: a female terminal; and a male terminal to be fitted into the female terminal, wherein at least a part of at least one of the female and male terminals contacting the other terminal thereof is made of the above described tin-plated product.

According to the present invention, it is possible to produce a tin-plated product which has a very low coefficient of friction. This tin-plated product can be used as the material of connecting terminals for automotive vehicles and so forth even if the connecting terminals have a larger number of multipolar terminals.

### BRIEF DESCRIPTION OF THE DRAWING

The present invention will be understood more fully from the detailed description given herebelow and from the accompanying drawings of the preferred embodiments of the invention. However, the drawings are not intended to imply limitation of the invention to a specific embodiment, but are for explanation and understanding only.

In the drawings:

FIG. 1 is a graph showing the relationship between the thickness and coefficient of friction of coatings in Examples and Comparative Examples;

FIG. 2 is a graph showing X-ray diffraction patterns in Examples and Comparative Examples;

FIG. 3 is a scanning electron microphotograph (SEM photograph) of a surface of a tin-plated product in Example 2;

FIG. 4 is a SEM photograph of a surface of a tin-plated product in Example 4;

FIG. 5 is a SEM photograph of a surface of a tin-plated product in Example 5;

FIG. 6 is a SEM photograph of a surface of a tin-plated product in Comparative Example 1;

FIG. 7 is a SEM photograph of a surface of a tin-plated product in Comparative Example 2;

FIG. 8 is a SEM photograph of a surface of a tin-plated product in Comparative Example 3;

FIG. 9 is a SEM photograph of a cross section of a tin-plated product in Example 2;

FIG. 10 is a SEM photograph of a cross section of a tin-plated product in Comparative Example 1; and

FIG. 11 is an illustration for explaining an example of a connecting terminal using a tin-plated product according to the present invention.

### DESCRIPTION OF THE PREFERRED EMBODIMENTS

In a preferred embodiment of a tin-plated product according to the present invention, a coating of a composite material containing carbon particles in a tin layer is formed on a substrate by electroplating using a tin plating solution which contains carbon particles and an aromatic carbonyl compound.

The tin plating solution is preferably a tin plating solution of alkylarylsulfonic acid. The carbon particles may be any carbon particles, and are preferably scale-shaped (or flake-shaped) or soil-shaped graphite particles. The aromatic carbonyl compound is preferably an aromatic aldehyde or an aromatic ketone.

The concentration of carbon particles in the plating solution is preferably in the range of from 1 g/L to 80 g/L. If it is less than 1 g/L, carbon particles are insufficient to form a surface structure as a composite plating layer, and if it exceeds 80 g/L, no current flows to cause plating burning. The current density during electroplating is preferably in the range of from 5 A/dm² to 15 A/dm². If it is less than 5 A/dm², productivity is bad, and if it exceeds 15 A/dm², plating burning is caused. Furthermore, the preferred embodiment of a tin-plated product according to the present invention is characterized by the structure of the outermost surface, and is not influenced by underlayer. Therefore, the underlayer plating material maybe selected from various underlayer plating materials, such as Sn, Cu and Ni, in accordance with the kind of the substrate and the use thereof.

By the above described preferred embodiment of a method for producing a tin-plated product according to the present invention, it is possible to produce a tin-plated product wherein a coating of a composite material containing 0.1 to 1.5% by weight of carbon particles in a tin layer is formed on a substrate, the coating having a coefficient of friction which is 0.20 or less, preferably 0.13 or less, with respect to the same kind of a tin-plated product, a contact resistance of 1.0 mΩ or less and a glossiness of 0.29 or more.

The thickness of a coating in the preferred embodiment of a tin-plated product according to the present invention is preferably in the range of from 0.5 μm to 10 μm, and more preferably in the range of from 1 μm to 10 μm. If the thickness of the coating is less than 0.5 μm, the deterioration of contact resistance with age is increased by the oxidation of tin or the like, so that connecting reliability serving as an important function of a connecting terminal is bad. On the other hand, if the thickness of the coating exceeds 10 μm, production efficiency is bad.

On the surface of the coating of the preferred embodiment of a tin-plated product according to the present invention, a plurality of islands of protrusions spaced from each other are formed. Each of the protrusions contains carbon particles. It is considered that such islands of protrusions are formed by adding an aromatic carbonyl compound, such as an aromatic aldehyde or an aromatic ketone, to a tin plating solution. That is, it is considered that, if an aromatic carbonyl compound is added to a tin plating solution, the dispersed state of carbon particles in the tin plating solution becomes a weak aggregation state to form a coating wherein islands of carbon particles are dispersed in a tin matrix, so that islands of protrusions are formed on the surface of the coating of a tin-plated product. In conventional coatings containing carbon particles as composite materials, various wetting agents are added to sufficiently disperse carbon particles to form a coating which contains carbon particles substantially uniformly dispersed in a tin matrix. If each of islands of protrusions spaced from each other contains carbon particles as the preferred embodiment of a tin-plated product according to the present invention, it is possible to form a coating having a lower coefficient of friction. That is, it is considered that, if the islands of protrusions are thus formed on the surface of the coating of the tin-plated product, the number of contact points on the surface serving as a contact surface is decreased, and if each of the protrusions contains carbon particles being lubricating particles, the coefficient of friction during friction is decreased. If a tin plating solution containing carbon particles and no aromatic carbonyl compound is used as conventional methods, it is not possible to form the above described islands of protrusions, and the coefficient of friction is higher than that of the preferred embodiment of a tin-plated product according to the present invention since carbon particles are substantially uniformly dispersed on the surface of the tin-plated product.

In the preferred embodiment of a tin-plated product according to the present invention, the orientation plane of the tin matrix is (101) plane. It is considered that the coating comprises fine crystal grains, so that the characteristics of the coating is greatly changed by the growth direction of the crystal grains. Therefore, it is considered that, if the crystal orientation of carbon particles as a composite material and the orientation of crystal particles in the tin matrix are optimum, the tin matrix is easily deformed by friction, so that the coefficient of friction is greatly decreased in corporation with the lubricity of carbon particles. Furthermore, in conventional composite plated products containing tin and graphite particles, the orientation planes of a tin matrix are (400) and (211) planes. It is considered that such a coating wherein the orientation plane of the tin matrix is (101) plane is formed by adding an aromatic carbonyl compound, such as an aromatic aldehyde or an aromatic ketone, to a tinplating solution. That is, it is considered that, if an aromatic carbonyl compound is added to a tin plating solution, the dispersed state of carbon particles in the tin plating solution becomes a weak aggregation state to form a coating wherein the orientation plane of the tin matrix is (101) plane. In conventional coatings wherein carbon particles are dispersed in a tin matrix as a composite material, various wetting agents are added to sufficiently disperse carbon particles to form a coating wherein the orientation planes of the tin matrix are (400) and (211) planes. However, it is possible to form a coating having a lower coefficient of friction by forming a coating wherein the orientation plane of the tin matrix is (101) plane as the preferred embodiment of a tin-plated product according to the present invention. That is, it is considered that the coefficient of friction during friction is decreased by thus forming a coating wherein the orientation plane of the tin matrix is (101) plane. If a tin plating solution containing carbon particles and no aromatic carbonyl compound is used as conventional methods, it is not possible to form the above described coating wherein the orientation plane of the tin matrix is (101) plane, so that the coefficient of friction is higher than that in the preferred embodiment of a tin-plated product according to the present invention.

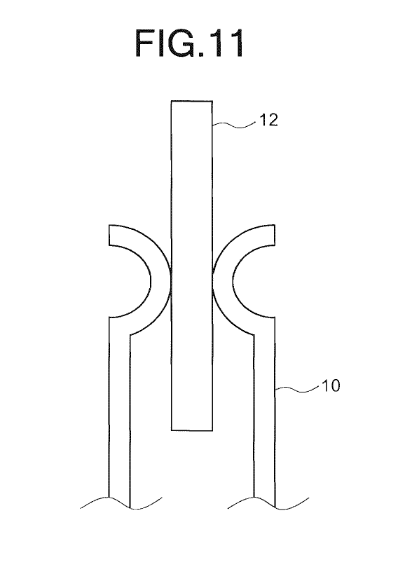

As shown in FIG. 11, if at least one of a female terminal 10 of a connecting terminal and a male terminal 12 fitted into the female terminal 10 is formed of a tin-plated product according to the present invention, it is possible to provide a connecting terminal which has a very low coefficient of friction. In this case, only a part of at least one of the female terminal 10 and male terminal 12 contacting the other terminal may be formed of a tin-plated product according to the present invention.

Examples of a tin-plated product according to the present invention will be described below in detail.

### Examples 1-5

First, there was prepared a tin plating solution containing 60 g/l of metal tin (containing 600 ml/l of tin alkylarylsulfonate (METASU SM produced by YUKEN INDUSTRY CO., LTD.) as a metallic tin salt) and 113 g/l of free acid (containing 84 ml/l of alkylarylsulfonic acid (METASU AM produced by YUKEN INDUSTRY CO., LTD.) as a free acid). To the tinplating solution, 30 ml/l of a surface active agent for tin plating (METASU LSA-M produced by YUKEN INDUSTRY CO., LTD.) was added. I addition, 20 g/L of scale-shaped (or flake-shaped) graphite particles (Graphite SGP-3 produced by SEC Corporation) having a mean particle diameter of 3.4 μm was added thereto to be dispersed therein. Moreover, 30 ml/l of benzaldehyde serving as an aromatic carbonyl compound was added thereto. Furthermore, the mean particle diameter of the graphite particles was obtained as follows. First, 0.5 g of graphite particles were dispersed in 50 g of a solution containing 0.2% by weight of sodium hexametaphosphate, and further dispersed by ultrasonic waves. Then, particle diameters of the graphite particles in a distribution based on volume were measured by means of a laser light scattering particle-size distribution measuring device, and a particle diameter at 50% in a cumulative distribution was assumed as the mean particle diameter.

Each of substrates of a Cu—Ni—Sn alloy (NB-109EH produced by Dowa Mining, Co., Ltd.) having a thickness of 0.25 mm was put into a tin plating bath containing the above described tin plating solution to be electroplated at a temperature of 25° C. and at a current density of 10 A/dm² using a tin plate as an anode while stirring the solution with a stirrer to produce a tin-plated product wherein a composite coating of tin and graphite particles having a thickness shown in Table 1 was formed. Furthermore, the thickness of the composite coating was calculated from a mean value of thicknesses at eight points by the fluorescent X-ray spectrometric method for measuring thickness.

After the tin-plated produce thus obtained was cleaned by ultrasonic cleaning to remove graphite particles adhering to the surface thereof, the content of carbon in the composite coating of the tin-plated product was calculated, and the coefficient of friction of the tin-plated product was calculated. In addition, the contact resistance, glossiness and hardness of the tin-plated product were measured. Moreover, the shape of surface of the tin-plated product was observed, and the orientation of a tin matrix was evaluated.

Test pieces were cut out of each of the obtained tin-plated products (containing the substrates) to be prepared for analyses of tin and carbon, respectively. The content by weight (X % by weight) of tin in the test piece was obtained by the plasma spectroscopic analysis by means of an ICP device (IRIS/AR produced by Jarrell Ash Corporation), and the content by weight (Y % by weight) of carbon in the test piece was obtained by the combustion infrared-absorbing analysis method by means of a carbon/sulfur microanalyzer (EMIA-U510 produced by HORIBA, Ltd.). Then, the content by weight of carbon in the tin coating was calculated as Y/(X+Y). Thus, the content by weight of carbon was in the range of from 0.6% by weight to 1.2% by weight in Examples 1 through 5.

As the coefficient of friction of each of the tin-plated products, the coefficient of friction between test pieces cut out of each of the obtained tin-plated products was obtained. The coefficient (μ) of friction between the test pieces was calculated as follows. One of two test pieces was indented to be used as an indenter (R: 3 mm), and the other test piece was used as an evaluating sample. A load cell was used for sliding the indenter at a moving speed of 60 mm/min while pushing the indenter against the evaluating sample at a load of 3 N. Thus, a force (F) applied in horizontal directions was measured for calculating the coefficient (μ) from μ=F/N. Thus, the coefficient of friction was in the range of from 0.09 to 0.14 in Examples 1 through 5.

The contact resistance of each of the tin-plated products was measured at a sliding load of 100 gf when the sliding load was changed from 0 gf to 100 gf at an open voltage of 200 mV and at a current of 10 mA by the alternating four-terminal method based on JIS C5402. Thus, the contact resistance was in the range of from 0.5 m0 to 1.0 mΩ in Examples 1 through 5.

As the glossiness of each of the tin-plated products, the luminous reflection density thereof was measured by means of a gloss meter (Densitometer ND-1 produced by Nippon Denshoku Kogyo, Co., Ltd.). Thus, the glossiness was in the range of from 0.29 to 0.77 in Examples 1 through 5.

As the hardness of each of the tin-plated products, the Vickers hardness thereof was measured by means of a microhardness tester (Microhardness Tester DMH-1 produced by Matuzawa Seiki, Co., Ltd.). Thus, the Vickers hardness thereof was in the range of from Hv16 to Hv97 in accordance with the thickness of the coating in Examples 1 through 5.

The shape of surface of each of the tin-plated products was observed by a scanning electron microscope (SEM). Thus, a large number of islands of protrusions were formed on the surface thereof in Examples 1 through 5.

With respect to the orientation of the tin matrix, peaks in X-ray diffraction were measured by means of an X-ray diffractometer (XRD) (RAD-rB produced by Rigaku Corporation), and the plane orientation of the strongest peak of the tin matrix was evaluated as the orientation of crystal of the coating. Furthermore, Cu—Kα was used as a vessel, and measurement was carried out at 50 kV and 100 mA. In addition, a scintillation counter, a wide angle goniometer and a curved crystal monochromator were used. The scanning range 2 θ/θ was 10 to 90°, and the step width was 0.05°. The scanning mode was FT, and the sampling time was 1.00 second. Thus, the orientation plane of the tin matrix was (101) plane in Examples 1 through 5.

### Example 6

A tin-plated product was produced by the same method as that in Examples 1-5, except that scale-shaped graphite particles (Graphite SGP-5 produced by SEC Corporation) having a mean particle diameter of 5 μm were used as carbon particles and that the thickness of the coating was 1.0 μm. By the same methods as those in Examples 1-5, the content of carbon in the coating of the tin-plated product thus obtained was calculated, and the coefficient of friction thereof was calculated. In addition, the contact resistance, glossiness and hardness of the tin-plated product were measured. Moreover, the shape of surface of the tin-plated product was observed, and the orientation of a tin matrix thereof was evaluated. Thus, the content of carbon was 1.2% by weight, and the coefficient of friction was 0.13. In addition, the contact resistance was 0.8 mΩ, the glossiness was 1.09, and the Vickers hardness was Hv65. Moreover, a large number of islands of protrusions were formed on the surface, and the orientation plane of the tin matrix was (101) plane.

### Example 7

A tin-plated product was produced by the same method as that in Example 6, except that soil-shaped graphite particles (Graphite HOP produced by Nippon Graphite, Co., Ltd.) having a mean particle diameter of 4 μm were used. By the same methods as those in Examples 1-5, the content of carbon in the coating of the tin-plated products thus obtained was calculated, and the coefficient of friction thereof was calculated. In addition, the contact resistance, glossiness and hardness of the tin-plated product were measured. Moreover, the shape of surface of the tin-plated product was observed, and the orientation of a tin matrix thereof was evaluated. Thus, the content of carbon was 0.7% by weight, and the coefficient of friction was 0.13. In addition, the contact resistance was 0.9 mΩ, the glossiness was 0.72, and the Vickers hardness was Hv66. Moreover, a large number of islands of protrusions were formed on the surface, and the orientation plane of the tin matrix was (101) plane.

### Comparative Examples 1-3

Tin-plated products were produced by the same method as that in Examples 1-5, except that a tin plating bath containing stannous sulfate (26 g/l as metallic tin), 140 g/l of sulfuric acid, 5 g/l of phenol, 1 g/l of dibutyl aniline and scale-shaped graphite particles having a mean particle diameter of 3.4 μm was used as described in Japanese Patent Laid-Open No. 61-227196 and that the thickness of the coating was 1.0 μm, 5.0 μm and 10 μm, respectively. Furthermore, no aromatic carbonyl compound was added to the tin plating bath used in these comparative examples. By the same methods as those in Examples 1-5, the content of carbon in the coating of each of the tin-plated products thus obtained was calculated, and the coefficient of friction thereof was calculated. In addition, the contact resistance, glossiness and hardness of each of the tin-plated products were measured. Moreover, the shape of surface of each of the tin-plated products was observed, and the orientation of a tin matrix thereof was evaluated. Thus, the content of carbon was 0.5% by weight, and the coefficient of friction was in the range of from 0.21 to 0.27. In addition, the contact resistance was in the range of from 0.4 mΩ to 0.6 mΩ, the glossiness was in the range of from 0.19 to 0.22, and the Vickers hardness was in the range of from Hv10 to Hv68 in accordance with the thickness of the coating. Moreover, the surface of the coating was rough, and carbon particles were uniformly dispersed on the surface thereof. The orientation planes of the tin matrix were (211) and (400) planes.

### Comparative Examples 4-6

Tin-plated products were produced by the same method as that in Examples 1-5, except that a tin plating bath containing no additive for bright plating was used and that the thickness of the coating was 1.0 μm, 5.0 μm and 10 μm, respectively. Furthermore, no aromatic carbonyl compound was added to the tin plating bath used in these comparative examples. By the same methods as those in Examples 1-5, the content of carbon in the coating of each of the tin-plated products thus obtained was calculated, and the coefficient of friction thereof was calculated. In addition, the contact resistance, glossiness and hardness of each of the tin-plated products were measured. Moreover, the shape of surface of each of the tin-plated products was observed, and the orientation of a tin matrix thereof was evaluated. Thus, the content of carbon was in the range of from 0.7% by weight to 0.9% by weight, and the coefficient of friction was in the range of from 0.22 to 0.28. In addition, the contact resistance was 0.5 mΩ, the glossiness was in the range of from 0.26 to 0.27, and the Vickers hardness was in the range of from Hv13 to Hv64 in accordance with the thickness of the coating. Moreover, the surface of the coating was rough, and carbon particles were uniformly dispersed on the surface thereof. The orientation planes of the tin matrix were (211) and (400) planes.

### Comparative Example 7

After a tin coating having a thickness of 1.0 μm was formed on the same substrate as that of Examples 1-5 at a temperature of 25° C. and at a current density of 10 A/dm² using a tin plating solution containing stannous sulfate (60 g/l as metallic tin) and 60 g/l of sulfuric acid, a tin-plated material thus obtained was treated by a reflow treatment at 240° C. to form a reflow-treated tin-plated material. By the same methods as those in Examples 1-5, the coefficient of friction of the reflow-treated tin-plated product thus obtained was calculated, and the contact resistance, glossiness and hardness of thereof were measured. Moreover, the shape of surface of the reflow-treated tin-plated product was observed, and the orientation of a tin matrix thereof was evaluated. Thus, the coefficient of friction was 0.28. In addition, the contact resistance was 1.0 mΩ, the glossiness was 1.98, and the Vickers hardness was Hv80. Moreover, the surface of the coating was smooth, and no carbon particles were naturally observed on the surface thereof. The orientation planes of the tin matrix were (112) and (101) planes.

### Comparative Examples 8-11

Bright tin-plated products were produced by the same method as that in Examples 1-5, except that the tinplating solution contained no carbon particles and no aromatic carbonyl compound. By the same methods as those in Examples 1-5, the coefficient of friction of each of the tin-plated products thus obtained was calculated, and the contact resistance, glossiness and hardness thereof were measured. Moreover, the shape of surface of each of the tin-plated products was observed, and the orientation of a tin matrix thereof was evaluated. Thus, the coefficient of friction was in the range of from 0.28 to 0.35. In addition, the contact resistance was in the range of from 0.7 mΩ to 1.1 mΩ, the glossiness was in the range of from 1.55 to 1.96, and the Vickers hardness was in the range of from Hv16 to Hv86 in accordance with the thickness of the coating. Moreover, the surface of the coating was smooth, and no carbon particles were observed on the surface thereof. The orientation planes of the tin matrix were (112) and (101) planes.

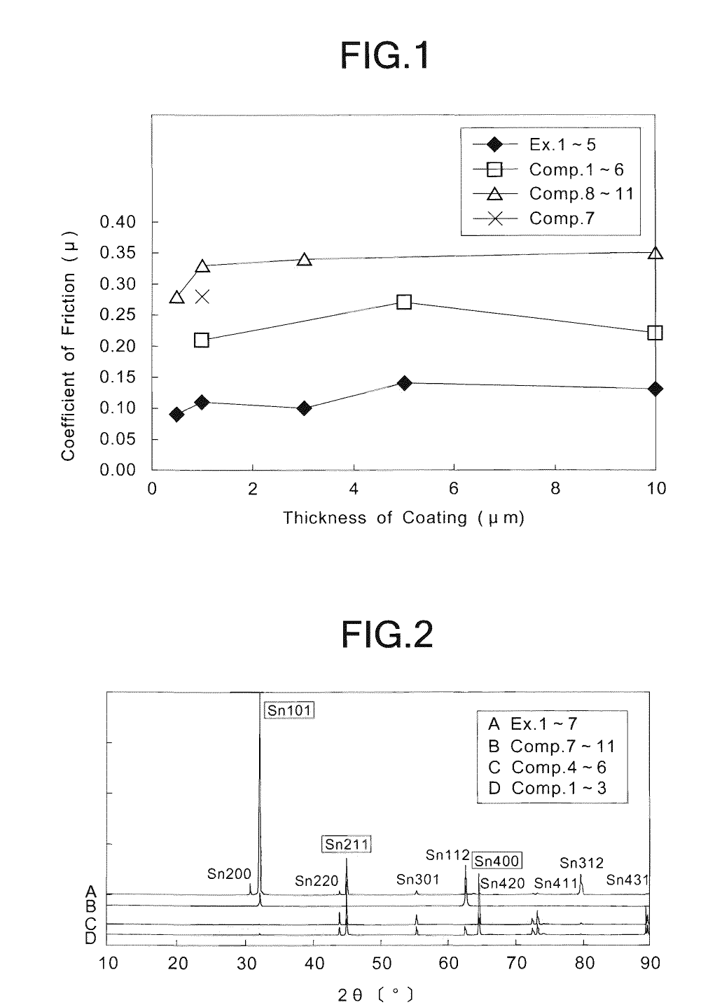

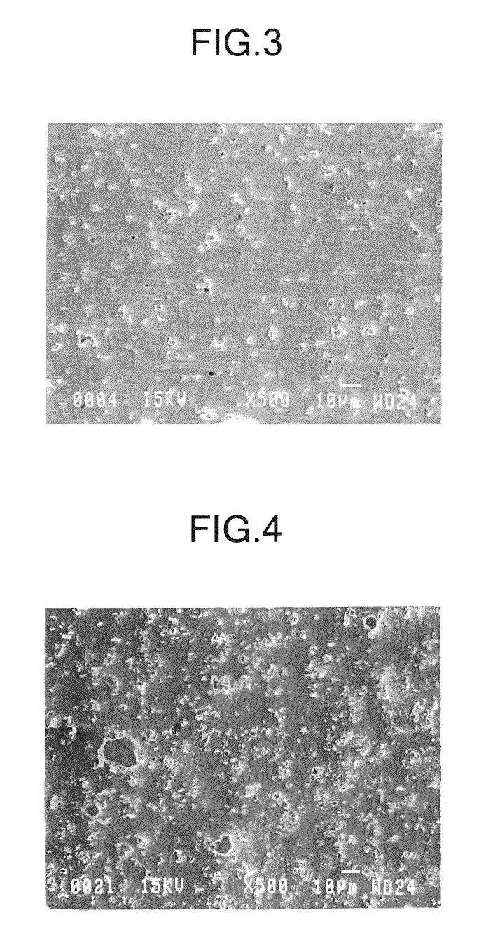

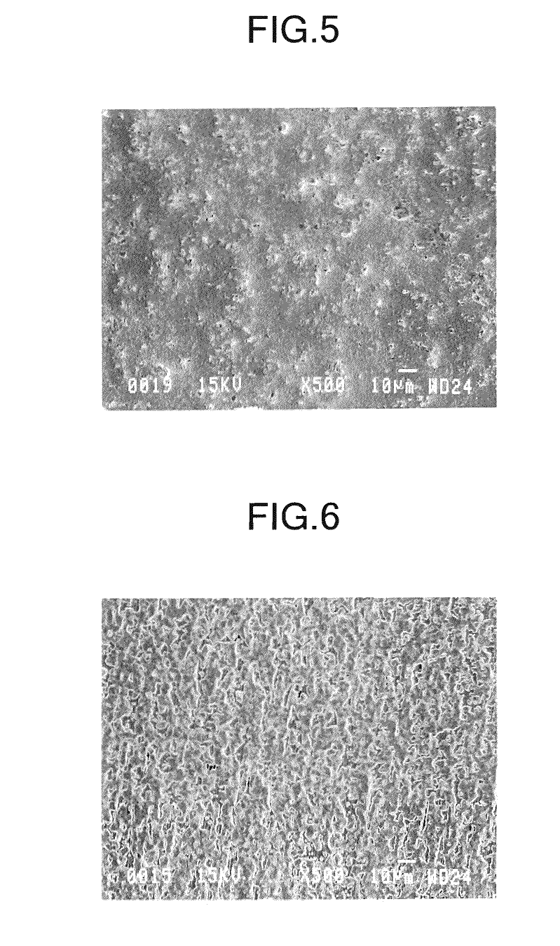

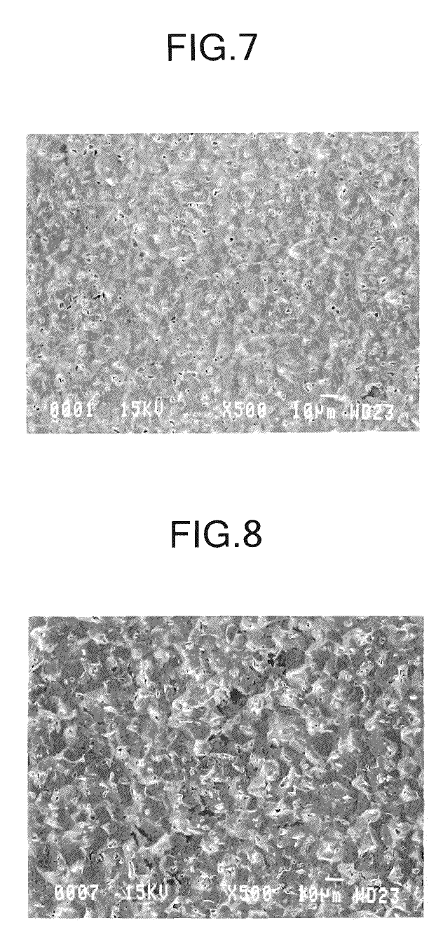

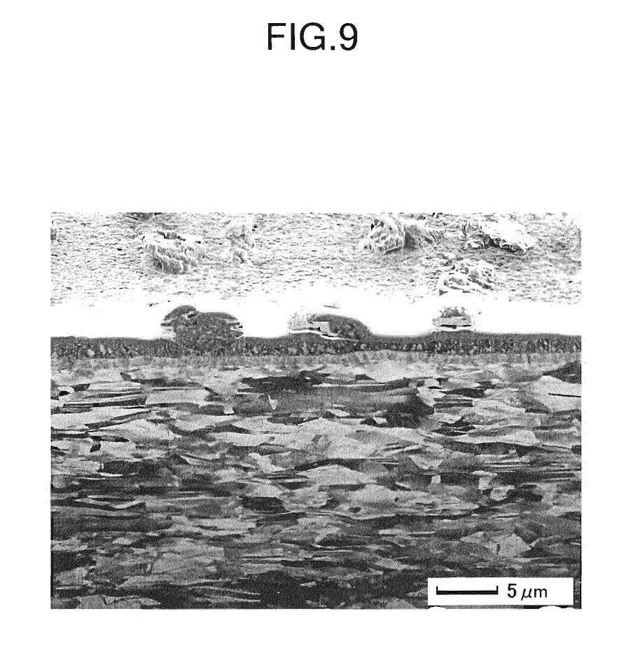

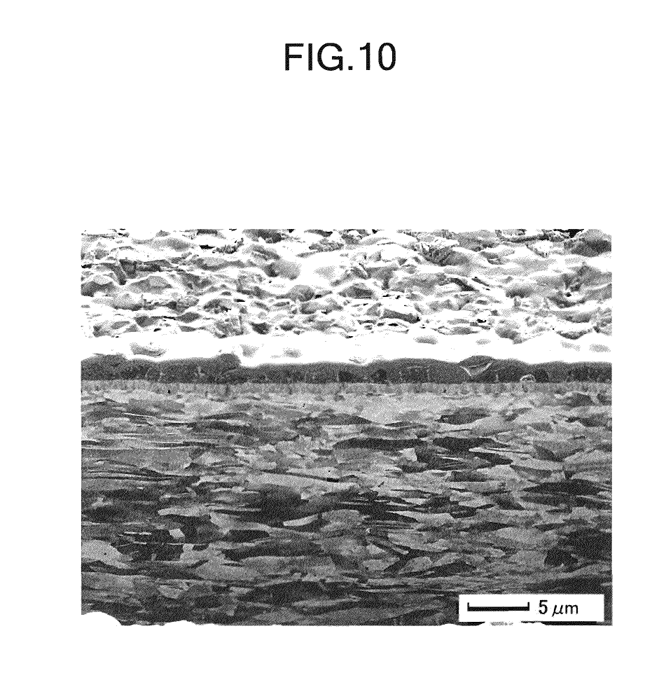

The results in these examples and comparative examples are shown Tables 1 and 2, and the relationship between the thickness and coefficient of friction of the coating is shown in FIG. 1. It can be seen from FIG. 1 that the coefficient of friction in each of Examples 1-5 is far lower than those in Comparative Examples 1-11 regardless of the variation in thickness of the coating. Furthermore, FIG. 2 shows X-ray diffraction patterns in Examples 1-7 and Comparative Examples 1-11. FIGS. 3 through 8 show the SEM photograph of a surface of each of the tin-plated products in Examples 2, 4, 5 and Comparative Examples 1-3, and FIGS. 9 and 10 show the SEM photograph of a cross section of each of the tin-plated products in Example 2 and Comparative Example 1.

TABLE 1

| | Carbon Particles | | | | |
|---|---|---|---|---|---|
| | | Particle | Concen- | Current | Thick- |
| | | Diameter | tration | Density | ness |
| | Shape | (μm) | (g/L) | (A/dm²) | (μm) |
| Ex. 1 | scale | 3 | 20 | 10 | 0.5 |
| Ex. 2 | scale | 3 | 20 | 10 | 1.0 |
| Ex. 3 | scale | 3 | 20 | 10 | 3.0 |
| Ex. 4 | scale | 3 | 20 | 10 | 5.0 |
| Ex. 5 | scale | 3 | 20 | 10 | 10 |
| Ex. 6 | scale | 5 | 20 | 10 | 1.0 |
| Ex. 7 | soil | 4 | 20 | 10 | 1.0 |
| Comp. 1 | scale | 3 | 100 | 2 | 1.0 |
| Comp. 2 | scale | 3 | 100 | 2 | 5.0 |
| Comp. 3 | scale | 3 | 100 | 2 | 10 |
| Comp. 4 | non-bright | 3 | 80 | 2 | 1.0 |
| | Sn—C | | | | |
| Comp. 5 | non-bright | 3 | 80 | 2 | 5.0 |
| | Sn—C | | | | |
| Comp. 6 | non-bright | 3 | 80 | 2 | 10 |
| | Sn—C | | | | |

| | | |
|---|---|---|
| Comp. 7 | reflow-treated tin-plated product | 1.0 |
| Comp. 8 | bright tin-plated product | 0.5 |
| Comp. 9 | bright tin-plated product | 1.0 |
| Comp. 10 | bright tin-plated product | 3.0 |
| Comp. 11 | bright tin-plated product | 10 |

TABLE 2

| | | | Con- | | | | Orien- |
|---|---|---|---|---|---|---|---|
| | Con- | | tact | | | | tation |
| | tent | COEF | Resis- | | | Shape | of Sn |
| | of C | of Fric- | tance | Gloss- | Hard- | of | Crys- |
| | (wt %) | tion | (mΩ) | iness | ness | Surface | tal |
| Ex. 1 | 1.2 | 0.09 | 0.5 | 0.77 | 97 | islands | 101 |
| Ex. 2 | 1.2 | 0.11 | 1.0 | 0.58 | 64 | islands | 101 |
| Ex. 3 | 1.1 | 0.10 | 0.9 | 0.32 | 40 | islands | 101 |
| Ex. 4 | 0.6 | 0.14 | 1.0 | 0.29 | 17 | islands | 101 |
| Ex. 5 | 0.7 | 0.13 | 0.8 | 0.31 | 16 | islands | 101 |
| Ex. 6 | 1.2 | 0.13 | 0.8 | 1.09 | 65 | islands | 101 |
| Ex. 7 | 0.7 | 0.13 | 0.9 | 0.72 | 66 | islands | 101 |
| Comp. 1 | 0.5 | 0.21 | 0.6 | 0.22 | 68 | rough | 400, |
| | | | | | | | 211 |
| Comp. 2 | 0.5 | 0.27 | 0.5 | 0.17 | 15 | rough | 400, |
| | | | | | | | 211 |
| Comp. 3 | 0.5 | 0.22 | 0.4 | 0.19 | 10 | rough | 400, |
| | | | | | | | 211 |
| Comp. 4 | 0.9 | 0.22 | 0.5 | 0.27 | 64 | rough | 400, |
| | | | | | | | 211 |
| Comp. 5 | 0.7 | 0.28 | 0.5 | 0.27 | 22 | rough | 400, |
| | | | | | | | 211 |
| Comp. 6 | 0.9 | 0.23 | 0.5 | 0.26 | 13 | rough | 400, |
| | | | | | | | 211 |
| Comp. 7 | — | 0.28 | 1.0 | 1.98 | 80 | smooth | 112, |
| | | | | | | | 101 |
| Comp. 8 | — | 0.28 | 1.1 | 1.55 | 86 | smooth | 112, |
| | | | | | | | 101 |
| Comp. 9 | — | 0.33 | 0.7 | 1.82 | 59 | smooth | 112, |
| | | | | | | | 101 |
| Comp. 10 | — | 0.34 | 1.0 | 1.96 | 27 | smooth | 112, |
| | | | | | | | 101 |
| Comp. 11 | — | 0.35 | 0.7 | 1.94 | 16 | smooth | 112, |
| | | | | | | | 101 |

While the present invention has been disclosed in terms of the preferred embodiment in order to facilitate better understanding thereof, it should be appreciated that the invention can be embodied in various ways without departing from the principle of the invention. Therefore, the invention should be understood to include all possible embodiments and modification to the shown embodiments which can be embodied without departing from the principle of the invention as set forth in the appended claims.

1-2. (canceled)

3. A tin-plated product comprising:
a substrate; and
a coating of a composite material which contains carbon particles in a tin layer, said coating being formed on said substrate,
wherein said tin-plated product has a coefficient of friction which is not greater than 0.18 with respect to the same kind of another tin-plated product as that thereof.

4. A tin-plated product as set forth in claim 3, wherein said coefficient of friction is not greater than 0.13.

5. A tin-plated product as set forth in claim 3, wherein said coating has a glossiness of not less than 0.29.

6. A tin-plated product as set forth in claim 3, wherein said coating has a thickness of 0.5 to 10 micrometers.

7. A tin-plated product as set forth in claim 3, wherein the content of carbon in said coating is in the range of from 0.1% by weight to 1.5% by weight.

8. A tin-plated product as set forth in claim 3, which has a contact resistance of not greater than 1.0 mΩ.

9. A tin-plated product as set forth in claim 3, wherein a plurality of protrusions spaced from each other are formed on a surface of said coating, and each of said protrusions contains said carbon particles.

10. A tin-plated product as set forth in claim 3, wherein an orientation plane of a tin matrix is (101) plane.

11. A connecting terminal comprising:
a female terminal; and
a male terminal to be fitted into said female terminal,
wherein at least a part of at least one of said female and male terminals contacting the other terminal thereof is made of a tin-plated product as set forth in claim 3.
